(19) United States
(12) Patent Application Publication
(10) Pub. No.: US 2011/0129558 A1
(43) Pub. Date: Jun. 2, 2011

(54) MOULD END-WALL SUPPORT FOR A BLOW-MOULDING MACHINE, AND BLOW-MOULDING MACHINE COMPRISING SAID END-WALL SUPPORT

(75) Inventor: Jean-Christophe Langlois, Octeville-Sur-Mer (FR)

(73) Assignee: SIDEL PARTICIPATIONS, Octeville-Sur-Mer (FR)

(21) Appl. No.: 13/001,376

(22) PCT Filed: Jun. 26, 2009
(86) PCT No.: PCT/FR2009/051232

§ 371 Date: Dec. 23, 2010

(30) Foreign Application Priority Data
Jun. 27, 2008 (FR) 08/03610

(51) Int. Cl. B29C 49/28; B29C 49/48; B29C 49/42

(52) U.S. Cl. 425/182; 425/522; 425/526

(57) ABSTRACT

The support (6) for the mould end-wall (2) comprises at least one part made of an insulating material, said part being interposed between said end-wall (2) of the mould and the mounting plate (5) in order to produce, in particular, a thermal bridge break between said end-wall and said mounting plate. This part may comprise, depending on the case, the cover (7) of the end-wall (2) or the spacer (20′) which is interposed between said cover and the device, enabling the support (6) to be assembled on the mounting plate (5). The insulating part of said support (6) also guarantees better heat exchange at the end-wall (2) of the mould with the heat-transfer fluid. The cover (7) of the end-wall (2) may include a lock ring (15) that cooperates with the segments (13) placed on the half-moulds (1). This lock ring (15) may also he made of an insulating plastic.

The invention relates to an improvement made to blow-moulding machines for moulding items such as bottles made of thermoplastic material, and more particularly to an improvement to a part of the mould used on this type of machine.

It concerns an improvement made to the support for the part that constitutes the mould end-wall, meaning the part comprising the cavity for forming the bottle bottom.

Blow-moulding machines such as those described in documents WO2006/010706 and U.S. Pat. No. 6,948,924 comprise multiple moulding units which are installed on a rotating carousel, and each unit comprises a bracket to support the mould.

Traditionally, the mould consists of two half-moulds, of the hinged type or another type, and a mould end-wall which is carried by a support. The half-moulds close around the support, and in particular around said mould end-wall, to lock it in place during the operation of stretch-blow moulding the bottle.

All such machines require various interventions which it must be possible to do quickly and under good working conditions for the operator(s).

Such interventions include periodic maintenance but also, in the case of multipurpose machines which can manufacture several types of bottles in the same day, they include operations consisting of changing the mould model or at least the cavities which shape the bottles manufactured on these machines. Thus operators may need to change dozens of mould end-walls and, of course, the supports that carry these moulds.

It must be possible to change the mould models quickly and this is why there is a means of quick assembly for the mould end-wall supports, interposed between said supports and the mould carrier unit; this means of quick assembly, such as the one described in document FR 2 902 688, facilitates these mould model changes.

All interventions on the blow-moulding machines, including this operation of changing the mould end-wall supports, are done under relatively difficult conditions for the operator(s) due to the ambient temperature around the machine.

The temperature is often relatively high, and can exceed 100 degrees Celsius; it results from the diffusion of heat from the preform, which is introduced at a very high temperature into each mould of the machine for the stretch blow moulding operation that will shape the bottle or other item.

The difficulties related to this operation of changing the mould end-wall supports are also increased because of the temperature of the support itself, as well as its weight which represents a significant load for the operator, considering that the number of parts to be changed on a blow-moulding machine may be in the dozens for example.

In addition, these parts that constitute the moulds must be handled with great care to avoid any damage that would render the moulds unusable.

The invention proposes an arrangement in the mould end-wall support which would provide a definitive solution to the above problems.

A first purpose of the invention is to reduce the heat transfers between the mould end-wall support and the rest of the machine, in order to improve the conditions for operators who work with said machine, for any type of intervention.

Another purpose of the invention is to improve conditions for the operator(s) who are responsible, for example, for manipulating the mould end-wall supports on the blow-moulding machine when the machine is set up to manufacture several series of bottles of different shapes and/or sizes; in this case, the invention improves conditions for the operator(s) both concerning the ambient temperature and the temperature of the mould end-wall supports to be manipulated.

Another goal of the invention is to decrease the unit weight of the mould end-wall supports in order to reduce the total load the operator must manipulate when changing said mould end-walls, and to reduce the weight these mould end-wall supports represent for the machine and that must be carried by the rotating part of said machine.

The general design of the support also improves the cooling conditions for the mould end-wall cavities, particularly due to the general improvement made to the arrangement of the supports for said mould end-walls.

The arrangement of the invention also improves the service life of the mould end-wall; in particular it improves the service life of mould end-walls made of aluminum which are traditionally associated with a steel support, for example, and in which a cooling liquid such as water circulates. In effect, one can observe that the invention eliminates the deterioration of mould end-walls made of aluminum.

In the following description, “mould end-wall” indicates the part of the mould which comprises the cavity for shaping the bottom of the item to be moulded; in other words, the mould end-wall corresponds to the part of the mould which shapes, for example, the bottom of the bottle.

The mould end-wall support of the invention is interposed between said mould end-wall and the mounting plate that is integrated with the bracket, or frame, and this support comprises at least one part made of insulating material in order to break the thermal bridge between said mould end-wall and the mounting plate of the mould carrier unit, and to eliminate the galvanic corrosion of said end-wall.

In a preferred arrangement of the invention, the insulating part is made of an acetal copolymer plastic material, particularly a polyacetal known as natural POM.

Still according to the invention, the mould end-wall comprises a circuit for the passage of a heat transfer fluid, and this circuit is cut in a spiral or other manner within said end-wall; it is cut into the face opposite the face which has the cavity for molding the bottle bottom.

This circuit for the heat transfer fluid is covered and tightly sealed by means of a cover which comprises a delivery pipe and a return pipe for said heat transfer fluid. This cover, interposed between the mould end-wall and the mounting plate, constitutes the insulating part which introduces a thermal bridge break between said mould end-wall and said mounting plate, and guarantees a better heat exchange between said mould end-wall and said heat transfer fluid.

The invention also improves the service life of the mould end-wall, particularly mould end-walls made of aluminum and associated with a support of ferrous material. The presence of the insulating part eliminates “battery” phenomena, and therefore the electrolysis that results from the circulation of the cooling liquid in said mould end-wall and leads to galvanic corrosion of such aluminum mould end-walls.

In another arrangement of the invention, the cover of the mould end-wall is machined to comprise a turned portion which acts as a seating for a lock ring that cooperates with segments circularly arranged in arcs on the half-moulds; said lock ring is also made of insulating material.

This lock ring performs several technical functions: it constitutes a thermal barrier, and it also centers the support relative to the half-moulds and supports the pressure that is exerted on the mould end-wall during the bottle blow-moulding operation.

Preferably, this lock ring is made of a moulded thermoplastic polymer material such as PEI (polyetherimide), PPS (polyphenylene sulfide), or other material. It also allows eliminating the repetitive lubrication operation which consists of applying a lubricant to the half-mould parts it cooperates with and which rub when the mould is opened and closed.

Still according to the invention, the support comprises a spacer between the cover for the mould end-wall and the mounting plate integrated with the bracket; this spacer allows modifying the support configuration and adapting the position of the mould end-wall to that of the half-moulds when changing the shapes and/or dimensions of the items to be moulded on the machine. This spacer can also be made of an insulating plastic material such as natural POM for example.

In another arrangement of the invention, having a support for the mould end-wall which comprises:
a “fixed” part comprising a pedestal fixed to the mounting plate which itself is integrated with the bracket of the mould carrier unit,
a removable, interchangeable part which cooperates with the half-moulds,
a means for assembling the two parts, with said removable part acting as an interchangeable support comprising at least:
a collar, which serves of base, and which cooperates with said pedestal of the fixed part,
a cover to which the mould end-wall is fixed,
   said interchangeable support comprises at least one insulating part which acts as a thermal bridge break between said end-wall and said collar.

Still according to the invention, in the case of a mould end-wall support made of two parts, the insulating part which acts as a thermal bridge break either consists of the cover of said mould end-wall, or the spacer, or both, meaning said cover and said spacer; the cover can also be arranged to act as a seating for the lock ring which anchors said mould end-wall to the half-moulds.

In another arrangement of the invention, the spacer comprises a central channel which carries the heat transfer fluid directly to the center of the mould end-wall, through the cover and from the collar, and also comprises several channels which are parallel to said central channel, with at least one of these channels used as a return for the heat transfer fluid.

In another arrangement of the invention, a metal plate for assembly is interposed between the cover of the end-wall and the spacer and between the spacer and the collar which is attached to the pedestal.

The invention will be further detailed by means of the following description and the attached drawings which are provided for illustrative purposes only, in which:

FIG. 1 shows a cutaway view, along a plane passing through the mould axis, of a first example of a mould end-wall support of the invention in which the cover is made of insulating plastic material,

FIG. 2 shows a cutaway view of an assembly consisting of a cover made of plastic material and a lock ring that is also made of plastic material,

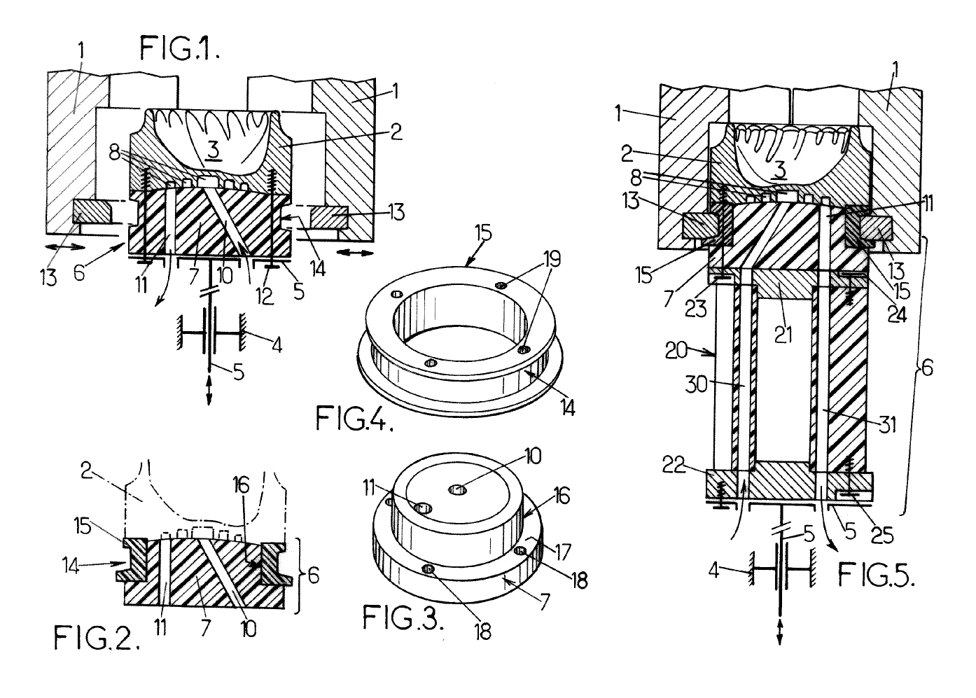

FIG. 3 shows a perspective view of the cover arranged to accept the lock ring,

FIG. 4 also shows a perspective view, but of the lock ring,

FIG. 5 shows a cutaway view, still along a plane passing through the mould axis, of a mould end-wall support comprising a spacer acting as an adaptor for format changes for items to be moulded, said spacer also being made of an insulating plastic material,

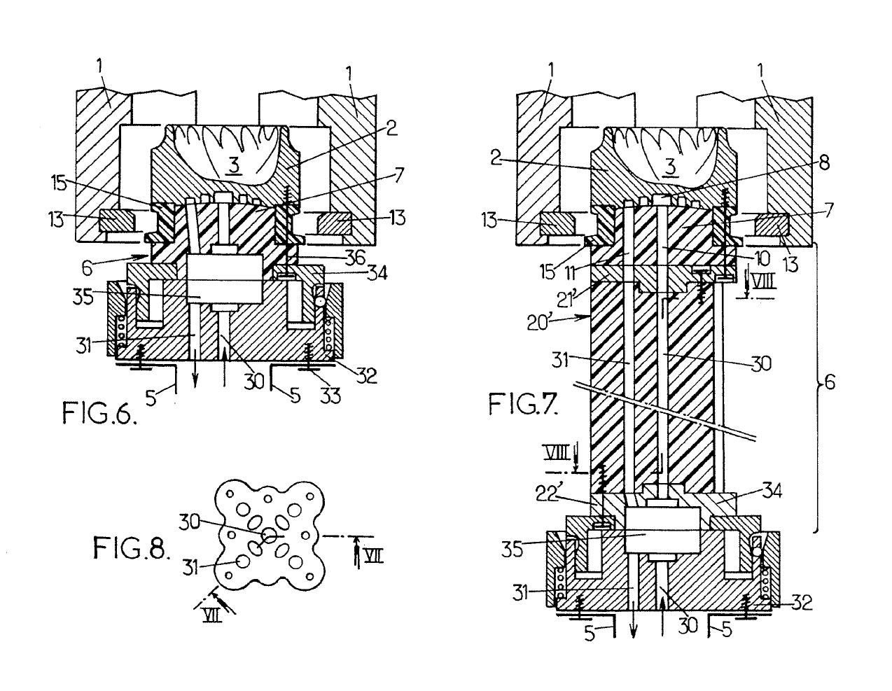

FIG. 6 shows, again in a cutaway view, another embodiment of an insulating mould end-wall support, said support using the means of quick assembly described in the previously cited document FR 2 902 688,

FIG. 7 is a cutaway view along 7-7 in FIG. 8, showing a mould end-wall support with a spacer and with the aforementioned means of quick assembly,

FIG. 8 is a cutaway view along 8-8 in FIG. 7, showing the spacer and the distribution of its various channels.

FIG. 1 shows the component elements of the mould, which are the half-moulds (1) partially represented and the mould end-wall (2) which has an upper surface comprising, in the form of a cavity, the impression (3) of the bottom of the item to be moulded, such as a bottle for example.

This mould is part of what is called a mould carrier unit. In general, a blow-moulding machine comprises several dozen mould carrier units, arranged radially on a carousel which does not appear in the figure.

The component elements of the mould are supported by a bracket (4) which acts as a frame. Said bracket (4) is integrated with the carousel of the machine. This bracket (4) can support the end-wall (2) directly but generally, as is shown in the previously cited documents WO2006/010706 and U.S. Pat. No. 6,948,924, it comprises a mounting plate (5) to which is attached the support (6) for the mould end-wall (2). This mounting plate (5) is vertically mobile when controlled by appropriate control means, and guided relative to said bracket (4).

Several versions of this support (6) for the end-wall (2) are represented in the different figures. In all versions, the support (6) comprises at least one part which acts as an insulating part and as a thermal bridge break between said end-wall (2) and the mounting plate (5) in order to avoid transmitting heat from the mould to the bracket (4), and in general to the structure of the blow-moulding machine. This insulating part, which will be detailed in the description of the different embodiments, is preferably made of a plastic material such as, for example, an acetal copolymer and in particular a polyacetal known as natural POM.

The support (6), represented in FIG. 1, consists of a single part called the cover (7) in the rest of the description. This cover (7) is interposed between the mounting plate (5) and the mould end-wall (2) and is in contact with the lower face of the mould end-wall (2). Said face, opposite the one which bears the cavity for moulding the bottle bottom, comprises a circuit (8) cut into the face in a spiral or other manner to allow the passage of a heat transfer fluid.

The upper surface of the cover (7) is in contact with the mould end-wall (2) and acts as a barrier, or cover, to seal off the spiraling circuit (8). This cover (7) therefore constitutes the support (6) for the mould end-wall (2) and comprises pipes (10) and (11) for the delivery and return of the heat transfer fluid. The pipe (10) carries the heat transfer fluid to the center of the end-wall (2), to the starting point of the spiraling circuit (8), under the cavity (3). The return pipe (11) is located at the end of the spiraling circuit (8).

The two pipes (10) and (11) are connected to piping, not represented, through the mounting plate (5) for example.

The end-wall (2) is attached to the cover (7) by means of screws (12) which, in this case, also constitute the assembly means of said cover (7), meaning for assembling the support (6) onto the mounting plate (5).

As was previously mentioned, the half-moulds (1) close around the support (6) before the moulding operation and lock it in position. This places the end-wall (2) in alignment with the half-moulds (1) and ensures continuity in the surfaces which will mould the wall of the blown item, which in this example is a bottle.

The lower part of the half-moulds (1) comprises segments (13) forming circular arcs, each segment cooperating with a groove (14) arranged, for example, directly on the support (6) for the mould end-wall (2), and in particular in the case in FIG. 1, on the perimeter of the cover (7) which constitutes said support (6).

When the half-moulds (1) are closed, the support (6) is imprisoned between the two half-moulds (1), and the mould end-wall (2) is in place for the blow-moulding operation.

Because of this construction for the support (6), particularly the presence of the cover (7), the mounting plate (5) is thermally insulated from the mould end-wall (2) as well as from the two half-moulds (1). This cover (7) is made of a plastic material, as was stated above.

This cover (7) also eliminates the battery effect which causes galvanic corrosion of the end-wall (2) when it is made of aluminum. The cover (7) acts as insulation and eliminates the electrolysis created by the passage of the heat transfer fluid, usually water, which can occur when the cover is made of ferrous material.

The holding in place of the support (6) by the two half-moulds (1) can also be done by means of a supplemental part which cooperates with the segments (13) of said half-moulds (1) and locks said support (6) in place with these segments.

This supplemental locking part, visible in FIG. 2, is in the shape of a ring (15) which is made of plastic material in order to ensure thermal insulation. This ring (15) is preferably obtained by moulding a thermoplastic copolymer to fulfill the function of centering and assembling the support with the two half-moulds (1).

As an example, the ring (15) is made of an injection-moulded thermoplastic material such as PEI (polyetherimide), PPS (polyphenylene sulfide), or another such material. This ring (15) provides the benefit of an extremely reliable part which is more economical over time than a metal part which wears.

This ring (15) comprises the same groove (14) as the one represented in FIG. 1. The groove (14) cooperates with the segments (13) arranged on each half-mould (1) as described above.

This lock ring (15) fits onto the cover (7) which comprises an arrangement for this purpose; said arrangement may consist of machining a turned portion (16) on the upper edge of said cover (7). In this manner, the ring (15) is positioned between the shoulder (17) of the turned portion (16), which forms a seat, and the lower face of the end-wall (2). Said lower face of said end-wall may also comprise a turned portion which allows centering said end-wall (2) relative to the cover (7) by means of said ring (15).

These three elements—the end-wall (2), the ring (15), and the cover (7)—can be assembled together and with the mounting plate (5) by means of the screws (12) which appear in FIG. 1.

The details of the cover (7) and the lock ring (15) are shown in FIGS. 2 to 4. In FIGS. 2 and 3, the cover (7) appears with its pipes (10) and (11) which allow the passage of the heat transfer fluid. Holes (18) and (19) can be seen in FIGS. 3 and 4; these holes (18) and (19) are respectively positioned on the cover (7) and the ring (15) to allow the passage of the screws (12).

When the ring (15) is made of plastic material, it can also contribute to insulating the different parts of the mould. In such case it has a certain flexibility and especially a certain elasticity to render it more wear-resistant than the same ring when made of metal.

This ring (15) of insulating material can also be used on a conventional metal support or on a support (6) comprising several parts of which one is an insulating part, as described below for the following figures. In all cases, the ring (15) eliminates the need for regular lubrication operations because of its self-lubricating properties.

FIG. 5 shows a support (6) consisting of several superimposed parts; in particular it comprises a spacer (20) placed between the cover (7) and the mounting plate (5). This spacer (20) allows adjusting the position of the end-wall (2) relative to the half-moulds (1) when there is a change in the mould size.

This spacer (20) extends between two plates:—an upper plate (21) which is interposed between said spacer (20) and the cover (7), and—a lower plate (22) which is situated between said spacer (20) and the mounting plate (5). The two plates (21) and (22) are preferably made of a light alloy; they allow attaching the different elements to each other in a conventional manner, from the mounting plate (5) to the end-wall (2), by means of several screws (23, 24, 25).

The spacer (20) may also constitute the insulation part for the support (6) and be formed by extrusion or moulding. It is then made of a plastic material such as polyacetal, the same material as was discussed for the cover (7).

The support (6) may comprise one or more insulation parts acting as a thermal bridge break. It may comprise, as mentioned above, an insulating part which consists of either the cover (7), the spacer (2), or both parts together.

In all cases, the ring (15) of the cover (7) can also be made of a plastic material such as polyetherimide, and act as insulation between the half-moulds (1) and the support (6).

The spacer (20) and the two plates (21) and (22) comprise pipes (30) and (31) which extend the pipes (10) and (11) of the cover (7) for the passage of the heat transfer fluid.

The use of the insulating part(s) and the thermal bridge break between the end-wall (2) and the mounting plate (5) makes it possible to supply to said end-wall (2) an efficient heat transfer fluid of a generally constant temperature. In addition, access to the heat transfer fluid at the center of the end-wall (2) is relatively direct and can be improved by the arrangements detailed below.

FIGS. 6 and 7 show a variant of the design for the support (6) of the invention, comprising a means of quick assembly interposed between said support and the mounting plate (5).

This means of quick assembly, described in the previously cited document FR 2 902 688, improves the time required to change out the mould end-walls (2). It consists of:—a pedestal (32) which is attached to the mounting plate (5) by means of screws (33), and—a collar (34) in the shape of a skirt, which receives the previously described component elements of the support (6).

This means of quick assembly also comprises pipes for the passage of heat transfer fluid and a fluid connector (35), diagrammed in a simple manner in the figures, which acts as a quick release coupling between the delivery pipes (30) and the return pipes (31) situated on each side of said means of quick assembly.

The support (6) represented in FIG. 6 is composed of the cover (7) and the collar (34) of the means of quick assembly. This cover (7) is made of a plastic material, in particular as described above for FIG. 1 or FIG. 2. The assembly of the different component elements of the support (6), which are the mould end-wall (2), the cover (7), possibly the ring (15), and the collar (34), is achieved by means of screws (36).

FIG. 7 shows a support (6) which comprises a spacer (20′) of a substantially different arrangement than that of the spacer represented in FIG. 5. This spacer (20′), which has a cross-section as represented in FIG. 8, is obtained similarly to the spacer (20) by extrusion or moulding and comprises several channels, two of them used for the passage of the heat transfer fluid:—the central channel (3), and—a lateral channel (31). The other channels are to reduce the weight of the part and/or to act as passages for other requirements.

Similarly to the embodiment described above for FIG. 5, this spacer (20′) extends between two plates:—an upper plate (21′) which is interposed between said spacer (20′) and the cover (7), and—a lower plate (22′) which is situated between said spacer (20′) and the mounting plate (5). The two plates (21′) and (22′) are preferably made of a light alloy; they attach the different elements to each other, from the mounting plate (5) to the mould end-wall (2), by means of several screws.

1.-12. (canceled)

13. A mould end-wall support for a blow-moulding machine for items made of thermoplastic material which is equipped with multiple moulding units arranged on a carousel and in which each of these units comprises a bracket acting as a frame to support the actual mould and in particular a mould constituted of two half-molds and said mould end-wall, said support being interposed between said mould end-wall and a mounting plate which is integrated with said bracket,
wherein the support comprises at least one part of insulating material, interposed between said mould end-wall and said mounting plate in order to form a thermal bridge break between the two and eliminate the galvanic corrosion of said mould end-wall.

14. A mould end-wall support according to claim 13, comprising an insulating part made of plastic material such as acetal copolymer and in particular a polyacetal known as natural POM.

15. A mould end-wall support according to claim 14, wherein said end-wall comprises a circuit for the passage of a heat transfer fluid, said circuit, cut in a spiral within said end-wall in the side opposite the surface with the cavity, being covered by a cover which comprises a delivery pipe and a return pipe for said heat transfer fluid, with said cover interposed between said end-wall and the mounting plate and constituting the insulating part of said support in order to introduce a thermal bridge break between said end-wall and the mounting plate, and to guarantee a better heat exchange between said end-wall and the heat transfer fluid.

16. A mould end-wall support according to claim 15, wherein the cover of the mould end-wall comprises a turned portion for seating a ring which cooperates with segments circularly arranged in arcs on the half-moulds in order to lock said mould end-wall in place, said lock ring also being made of insulating plastic material.

17. A mould end-wall support according to claim 16, wherein the ring is made of a thermoplastic material such as PEI (polyetherimide).

18. A mould end-wall support according to claim 16, wherein the ring is made of a material such as PPS (polyphenylene sulfide).

19. A mould end-wall support according to claim 15, comprising, between the cover of the mould end-wall and the mounting plate, a spacer which allows modifying the configuration of said support and adapting it to the type of mould when changing the shapes and/or dimensions of the items to be moulded, it being also possible for said spacer to be made of an insulating plastic material, such as natural POM for example.

20. An end-wall comprising:
a fixed part comprising a pedestal attached to the mounting plate which itself is integrated with the bracket of the mould carrier unit,
an interchangeable, removable part, which cooperates with the half-moulds,
a means for assembling the two parts,
with said removable part acting as an interchangeable support comprising at least:
a collar which cooperates with said pedestal of said fixed part,
a cover to which said mould end-wall is fixed,
wherein said interchangeable part comprises at least one insulating part which acts as a thermal bridge break between said end-wall and said collar.

21. A mould end-wall support according to claim 20, comprising an insulating part consisting of either the cover of the mould end-wall, or the spacer, or both said cover and said spacer; the cover may also, depending on the case, be arranged to act as a seating for the ring that locks said mould end-wall onto the two half-moulds.

22. A mould end-wall support according to either of claims 20, comprising a spacer having with a central channel for carrying the heat transfer fluid directly to the center of the mould end-wall through the cover and from the collar and the pedestal, and having several channels parallel to said central channel, with at least one of these channels, channel, being used for the return of the heat transfer fluid.

23. A mould end-wall support according to any one of claims 17, comprising metal plates for assembly which are respectively interposed between the cover of the mould end-wall and the spacer, and between the latter and, depending on the case, the mounting plate or the collar which is attached to the pedestal.

24. A blow-moulding machine equipped with several moulding units each arranged on a bracket which supports the mould and in particular a mould consisting of two half-moulds and a mould end-wall, said mould end-wall being supported by means of a support which itself is attached to a mounting plate integrated with said bracket, wherein at least one of said moulding units comprises a mould end-wall support according to any one of claims 13.

25. A mould end-wall support according to claim 20, comprising metal plates for assembly which are respectively interposed between the cover of the mould end-wall and the spacer, and between the latter and, depending on the case, the mounting plate or the collar which is attached to the pedestal.

26. A blow-moulding machine equipped with several moulding units each arranged on a bracket which supports the mould and in particular a mould consisting of two half-moulds and a mould end-wall, said mould end-wall being supported by means of a support which itself is attached to a mounting plate integrated with said bracket, wherein at least one of said moulding units comprises a mould end-wall support according to claim 20.
